(19) United States
(12) Patent Application Publication
(10) Pub. No.: US 2026/0190152 A1
(43) Pub. Date: Jul. 2, 2026

(54) PHYSICAL RANDOM ACCESS CHANNEL BASED ON FREQUENCY HOPPING

(71) Applicant: QUALCOMM Incorporated, San Diego, CA (US)

(72) Inventors: Luanxia YANG, Beijing (CN); Piyush GUPTA, Bridgewater, NJ (US); Xiaojie WANG, Hillsborough, NJ (US); Junyi LI, Greentown, PA (US)

(21) Appl. No.: 19/127,569

(22) PCT Filed: Dec. 31, 2022
(86) PCT No.: PCT/CN2022/144404

§ 371 Date: May 6, 2025

(51) Int. Cl. H04W 74/0833

(52) U.S. Cl. CPC H04W 74/0833

(57) ABSTRACT

Various aspects of the present disclosure generally relate to wireless communication. In some aspects, a user equipment (UE) may receive a physical random access channel (PRACH) configuration indicating a set of resources for a random access channel (RACH) preamble. The UE may receive an input radio frequency (RF) signal. The UE may select a starting frequency for a frequency hopping pattern for the RACH preamble. The UE may transmit the RACH preamble in the set of resources at the starting frequency and in accordance with the frequency hopping pattern, wherein transmitting the RACH preamble comprises a backscatter modulation of the input RF signal. Numerous other aspects are described.

### FIELD OF THE DISCLOSURE

Aspects of the present disclosure generally relate to wireless communication and to techniques and apparatuses for physical random access channel (PRACH) transmission based on frequency hopping.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

Some aspects described herein relate to a method of wireless communication performed by a user equipment (UE). The method may include receiving a physical random access channel (PRACH) configuration indicating a set of resources for a random access channel (RACH) preamble. The method may include receiving an input radio frequency (RF) signal. The method may include selecting a starting frequency for a frequency hopping pattern for the RACH preamble. The method may include transmitting the RACH preamble in the set of resources at the starting frequency and in accordance with the frequency hopping pattern, wherein transmitting the RACH preamble comprises a backscatter modulation of the input RF signal.

Some aspects described herein relate to a method of wireless communication performed by a network entity. The method may include outputting a PRACH configuration indicating a set of resources for a RACH preamble. The method may include receiving the RACH preamble on the set of resources at a starting frequency and in accordance with a frequency hopping pattern, wherein the transmission comprises a backscatter modulation of an input RF signal.

Other aspects provide: an apparatus operable, configured, or otherwise adapted to perform any one or more of the aforementioned methods and/or those described herein with reference to and as illustrated by the drawings; a non-transitory, computer-readable medium comprising computer-executable instructions that, when executed by a processor of an apparatus, cause the apparatus to perform the aforementioned methods and/or those described herein with reference to and as illustrated by the drawings; a computer program product embodied on a computer-readable storage medium comprising code for performing the aforementioned methods and/or those described herein with reference to and as illustrated by the drawings; and/or an apparatus comprising means for performing the aforementioned methods and/or those described herein with reference to and as illustrated by the drawings. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example base station (BS) and user equipment (UE), in accordance with the present disclosure.

FIG. 3 depicts an example disaggregated base station architecture.

FIGS. 4A, 4B, 4C, and 4D depict aspects of data structures for a wireless communications network in accordance with the present disclosure.

FIG. 5 is a diagram illustrating an example of an architecture of a radio frequency (RF) energy harvesting device, in accordance with some examples.

FIG. 6 is a diagram illustrating an example of an ultra-light IoT device.

FIG. 7 is a is a diagram illustrating an example physical random access channel (PRACH) signal transmission using inner layer fixed size frequency hopping and outer layer pseudo-random frequency hopping, in accordance with some examples.

FIG. 8 is a diagram illustrating an example of signaling for PRACH frequency hopping for ultra-light Internet of Things (IoT), in accordance with the present disclosure.

FIG. 9 is a diagram illustrating an example of synchronization prior to transmission of a random access channel (RACH) preamble using backscatter modulation, in accordance with the present disclosure.

FIG. 10 is a diagram illustrating examples of wakeup signaling and go-to-sleep signaling for RACH preamble transmission using backscatter modulation, in accordance with the present disclosure.

FIG. 11 shows a method for wireless communications by a UE.

FIG. 12 shows a method for wireless communications by a network entity.

FIG. 13 is a diagram illustrating an example of an implementation of code and circuitry for a communications device, in accordance with the present disclosure.

FIG. 14 is a diagram illustrating an example of an implementation of code and circuitry for a communications device, in accordance with the present disclosure.

### DETAILED DESCRIPTION

Aspects of the present disclosure provide apparatuses, methods, processing systems, and computer-readable mediums for random access channel transmission.

In various wireless communication networks, various client devices can be utilized that may be associated with different signaling and communication capabilities. For example, as 5G networks expand into industrial verticals and the quantity of deployed Internet-of-Things (IoT) devices grows, network service categories such as enhanced Mobile Broadband (eMBB), Ultra Reliable Low Latency Communications (URLLC), and massive Machine Type Communications (mMTC), etc., may be expanded to better support various IoT devices, which can include passive IoT devices, semi-passive IoT devices, ultra-light IoT devices, etc.

For example, passive IoT devices and semi-passive IoT devices are relatively low-cost user equipments (UEs) that may be used to implement one or more sensing and communication capabilities in an IoT network or deployment. In some examples, passive and/or semi-passive IoT sensors (e.g., devices) can be used to provide sensing capabilities for various processes and use cases, such as asset management, logistics, warehousing, manufacturing, etc. Passive and semi-passive IoT devices can include one or more sensors, a processor or micro-controller, and an energy harvester for generating electrical power from incident downlink radio frequency (RF) signals received at the passive or semi-passive IoT device.

Based on harvesting energy from incident downlink RF signals (e.g., transmitted by a network device such as a base station, gNB, etc.), energy harvesting devices (e.g., passive IoT devices, semi-passive IoT devices) can be provided without an energy storage element and/or can be provided with a relatively small energy storage element (e.g., battery, capacitor, etc.). Energy harvesting devices can be deployed on large scales, based on the simplification in their manufacture and deployment associated with implementing wireless energy harvesting (e.g., relative to an eMBB UE).

In a wireless communication network environment (e.g., cellular network, etc.), a network device (e.g., a base station or gNB) can be used to transmit downlink RF signals to energy harvesting devices. In one illustrative example, a base station or gNB can read and/or write information stored on energy harvesting IoT devices by transmitting the downlink RF signal. A downlink RF signal can provide energy to an energy harvesting IoT device and can be used as the basis for an information-bearing uplink signal transmitted back to the network device (or to another receiver) by the energy harvesting IoT device (e.g., based on reflecting or backscattering a portion of the incident downlink RF signal). The base station or gNB can read the reflected signal transmitted by the energy harvesting IoT device to decode the information transmitted by the IoT device (e.g., sensor information collected by one or more sensors included in the IoT device).

In some examples, for a given downlink signal with a given input RF power received at an energy harvesting device, a first portion of the input RF power is provided to the device's energy harvester (e.g., with a percentage being converted to useful electrical power based on the conversion efficiency of the harvester, and the remaining percentage wasted or dissipated as heat). A remaining, second portion of the input RF power is available for use in the backscattered uplink transmission (e.g., the second portion of the input power is reflected and modulated with the uplink communication).

Ultra-light IoT devices can include both a backscatter transmitter (e.g., a backscatter radio) and an active transmitter (e.g., an active radio). A backscatter transmitter can generate and transmit an uplink signal by reflecting and backscatter modulating an incident downlink signal. In some examples, an ultra-light IoT device can use a backscatter transmitter that is the same as or similar to a backscatter transmitter utilized by a passive or semi-passive IoT device. An active transmitter can use a battery or other energy storage element included in the ultra-light IoT device to generate and transmit an uplink signal. To transmit an uplink signal, the backscatter transmitter of an ultra-light IoT device must first receive a downlink signal that can be reflected and backscatter modulated. For example, the backscatter transmitter may be unable to transmit an uplink signal unless or until a continuous sine wave is received as a downlink signal from a base station, gNB, or other network device. The active transmitter of an ultra-light IoT device can perform uplink communication that is triggered by the ultra-light IoT device (e.g., without dependence on first receiving a downlink signal).

Ultra-light IoT devices may include only a small battery or energy storage element and may not sustain longer periods of uplink communication using the active transmitter of the ultra-light IoT device. For example, active transmission by an ultra-light IoT device may quickly deplete the onboard battery or other energy storage element(s) included in the ultra-light IoT device.

Physical random access channel (PRACH) signals and communications can be used by a UE (e.g., an ultra-light IoT device) to align the UE's uplink transmissions to a base station or gNB and gain access to (e.g., connect to) a wireless network associated with the base station or gNB. For example, PRACH signals can be used for initial access requests from a UE to a base station and to obtain time synchronization. To access the network, the UE can request access by transmitting a random access (RA) preamble (sometimes referred to as a PRACH preamble) through PRACH signals. The RA preamble can be detected by a PRACH receiver at the base station, which estimates the ID of the transmitted preamble and a propagation delay between the UE and the base station. The base station and UE are then time-synchronized according to a time alignment (TA) value (e.g., determined from the propagation delay estimate) transmitted from the base station prior to the uplink transmission.

A UE (e.g., an ultra-light IoT device) may utilize frequency hopping, which improves frequency diversity and reduces inter-cell interference. Frequency hopping may involve switching of a transmission frequency of a signal from one sub-carrier to another sub-carrier during transmission of the signal. The UE and a network entity may benefit from a mutual understanding of a starting time and frequency of the frequency hopping, as well as a frequency hopping pattern of the frequency hopping. However, there are situations in which a UE (e.g., an ultra-light IoT device) may not be fully (e.g., perfectly) synchronized in time and frequency with the network. For example, the UE may exit a long sleep and transmit a PRACH preamble prior to synchronizing with the network. As another example, the UE may not perform a form of synchronization (e.g., frequency synchronization and/or time synchronization). If frequency hopping does not take into account partially synchronized or asynchronous configurations, then collisions between UEs may occur or PRACH transmission or reception may fail. If time synchronization and frequency synchronization are both required, a UE (particularly an ultra-light IoT device) may use significant power and may require higher-cost components than if one or more of time synchronization or frequency synchronization is not performed.

Some techniques described herein enable PRACH transmission for partially synchronized or asynchronous UEs, such as ultra-light IoT devices. For example, a UE may transmit a random access channel (RACH) preamble on a set of resources configured for the UE for transmission of a RACH preamble. The UE may transmit the RACH preamble using backscatter modulation of an input RF signal. The UE may transmit the RACH preamble in accordance with a starting frequency and using the frequency hopping pattern (e.g., a first transmission of the RACH preamble may be located at the starting frequency). Furthermore, the UE may select the starting frequency. By the use of frequency selection, the occurrence of collisions between UEs (which may lead to failure to receive PRACH transmissions) may be reduced. Some techniques described herein provide group-based wakeup signaling and/or go-to-sleep signaling to indicate available PRACH resources (as compared to fully synchronizing with the network to identify available PRACH resources), which reduces power usage and cost of UEs.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

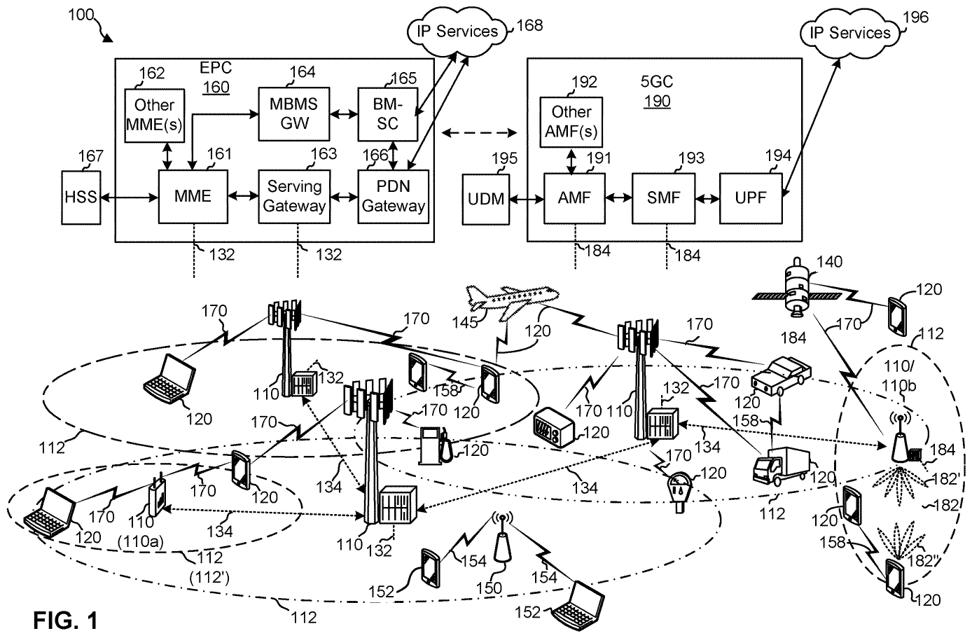

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IoT) device, an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects. BSs 110 and UEs 120 may communicate with one another using RF signaling. An RF signal comprises an electromagnetic wave of a given frequency that transports information through the space between a transmitter and a receiver.

A BS 110 may include, for example, a NodeB, an enhanced NodeB (eNB), a next generation enhanced NodeB (ng-eNB), a next generation NodeB (gNB or gNodeB), an access point (AP), a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

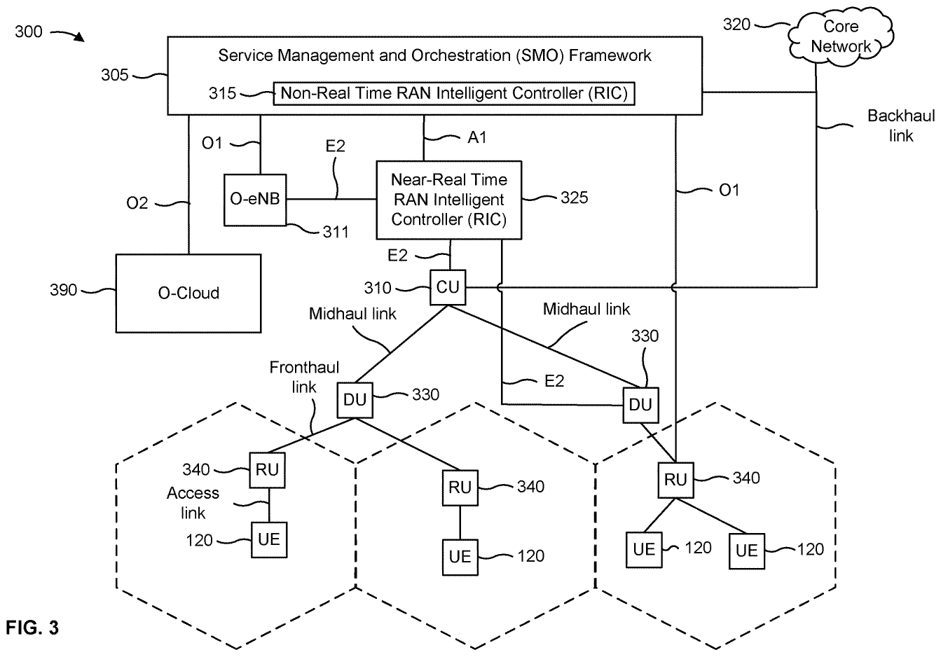

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated radio access network architecture, such as an Open RAN (O-RAN) architecture or a Virtualized RAN (VRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave or near mmWave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QoS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

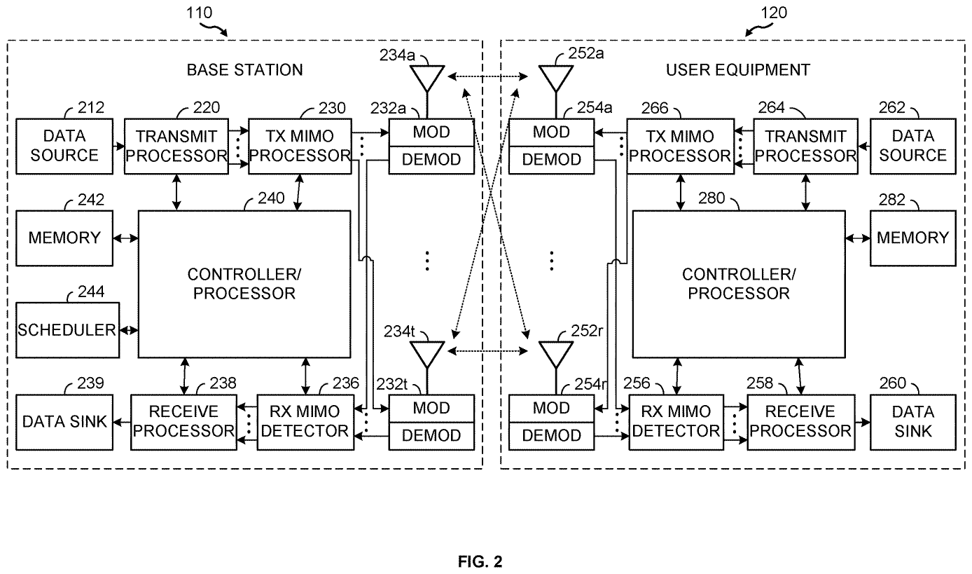

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), the secondary synchronization signal (SSS), the PBCH demodulation reference signal (DMRS), or the channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

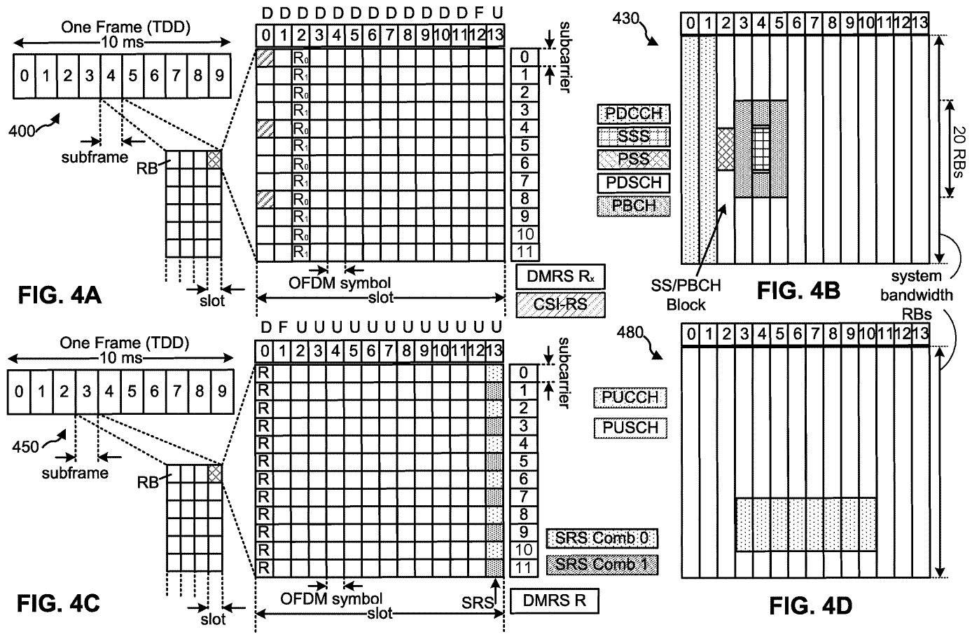

FIGS. 4A, 4B, 4C, and 4D depict aspects of data structures for a wireless communications network, such as wireless communications network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex, in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}×15 kHz, where u is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSS) for a UE (e.g., UE 120). The RSs may include demodulation RSs (DMRSs) and/or channel state information reference signals (CSI-RSs) for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., UE 120) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the physical uplink control channel (PUCCH) and DMRSs for the physical uplink shared channel (PUSCH). The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit sounding reference signals (SRSs). The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment and/or negative acknowledgment (ACK/NACK) feedback. The PUSCH carries data, and may additionally be used to carry a buffer status report (BSR), a power headroom report (PHR), and/or UCI.

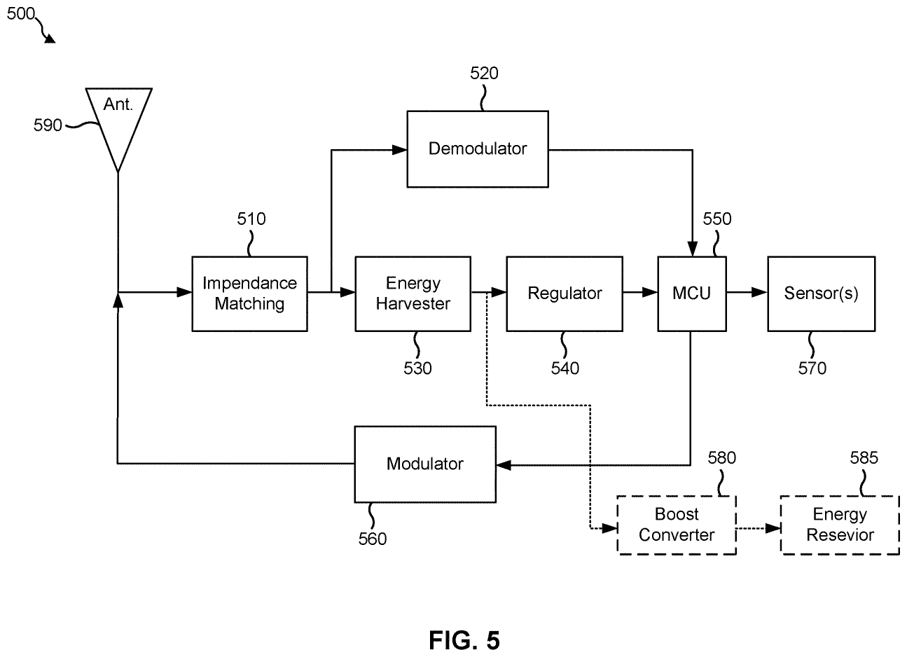

FIG. 5 is a diagram illustrating an example of an architecture of an RF energy harvesting device 500, in accordance with some examples. The RF energy harvesting device 500 can harvest RF energy from one or more RF signals received using an antenna 590. As used herein, the term “energy harvesting” may be used interchangeably with “power harvesting.” In some aspects, energy harvesting device 500 can be implemented as an IoT device, can be implemented as a sensor, etc., as will be described in greater depth below. In other examples, energy harvesting device 500 can be implemented as an RF identification (RFID) tag or various other RFID devices.

The energy harvesting device 500 includes one or more antennas 590 that can be used to transmit and receive one or more wireless signals. For example, energy harvesting device 500 can use antenna 590 to receive one or more downlink signals and to transmit one or more uplink signals. An impedance matching component 510 can be used to match the impedance of antenna 590 to the impedance of one or more (or all) of the receive components included in energy harvesting device 500. In some examples, the receive components of energy harvesting device 500 can include a demodulator 520 (e.g., for demodulating a received downlink signal), an energy harvester 530 (e.g., for harvesting RF energy from the received downlink signal), a regulator 540, a micro-controller unit (MCU) 550, and/or a modulator 560 (e.g., for generating an uplink signal). In some cases, the receive components of energy harvesting device 500 may further include one or more sensors 570.

The downlink signals can be received from one or more transmitters. For example, energy harvesting device 500 may receive a downlink signal from a network node or network entity (e.g., which may or may not be included in a same wireless network as the energy harvesting device 500). In some cases, the network entity can be a base station, gNB, etc., that communicates with the energy harvesting device 500 using a cellular communication network. For example, the cellular communication network can be implemented according to the 3G, 4G, 5G, and/or other cellular standards (e.g., including future standards such as 6G and beyond).

In some cases, energy harvesting device 500 can be implemented as a passive or semi-passive energy harvesting device, which performs passive uplink communication by modulating and reflecting a downlink signal received via antenna 590. For example, passive and semi-passive energy harvesting devices may be unable to generate and transmit an uplink signal without first receiving a downlink signal that can be modulated and reflected. In other examples, energy harvesting device 500 may be implemented as an active energy harvesting device, which utilizes a powered transceiver to perform active uplink communication. An active energy harvesting device is able to generate and transmit an uplink signal without first receiving a downlink signal (e.g., by using an on-device power source to energize its powered transceiver).

An active or semi-passive energy harvesting device may include one or more energy storage elements 585 (e.g., collectively referred to as an “energy reservoir”). For example, the one or more energy storage elements 585 can include batteries, capacitors, etc. In some examples, the one or more energy storage elements 585 may be associated with a boost converter 580. The boost converter 580 can receive as input at least a portion of the energy harvested by energy harvester 530 (e.g., with a remaining portion of the harvested energy being provided as instantaneous power for operating the energy harvesting device 500). In some aspects, the boost converter 580 may be a step-up converter that increases voltage from its input to its output (e.g., and steps down current from its input to its output). In some examples, boost converter 580 can be used to increase the harvested energy generated by energy harvester 530 to a voltage level associated with charging the one or more energy storage elements 585. An active or semi-passive energy harvesting device may include one or more energy storage elements 585 and may include one or more boost converters 580. A quantity of energy storage elements 585 may be the same as or different than a quantity of boost converters 580 included in an active or semi-passive energy harvesting device.

A passive energy harvesting device does not include an energy storage element 585 or other on-device power source. For example, a passive energy harvesting device may be powered using only RF energy harvested from a downlink signal (e.g., using energy harvester 530). As mentioned above, a semi-passive energy harvesting device can include one or more energy storage elements 585 and/or other on-device power sources. The energy storage element 585 of a semi-passive energy harvesting device can be used to augment or supplement the RF energy harvested from a downlink signal. In some cases, the energy storage element 585 of a semi-passive energy harvesting device may store insufficient energy to transmit an uplink communication without first receiving a downlink communication (e.g., minimum transmit power of the semi-passive device>capacity of the energy storage element). An active energy harvesting device can include one or more energy storage elements 585 and/or other on-device power sources that can power uplink communication without using supplemental harvested RF energy (e.g., minimum transmit power of the active device<capacity of the energy storage element). The energy storage element(s) 585 included in an active energy harvesting device and/or a semi-passive energy harvesting device can be charged using harvested RF energy.

As mentioned above, passive and semi-passive energy harvesting devices transmit uplink communications by performing backscatter modulation to modulate and reflect a received downlink signal. The received downlink signal is used to provide both electrical power (e.g., to perform demodulation, local processing, and modulation) and a carrier wave for uplink communication (e.g., the reflection of the downlink signal). For example, a portion of the downlink signal can be backscattered as an uplink signal and a remaining portion of the downlink signal can be used to perform energy harvesting.

Active energy harvesting devices can transmit uplink communications without performing backscatter modulation and without receiving a corresponding downlink signal (e.g., an active energy harvesting device includes an energy storage element to provide electrical power and includes a powered transceiver to generate a carrier wave for an uplink communication). In the absence of a downlink signal, passive and semi-passive energy harvesting devices cannot transmit an uplink signal (e.g., passive communication). Active energy harvesting devices do not depend on receiving a downlink signal in order to transmit an uplink signal and can transmit an uplink signal as desired (e.g., active communication).

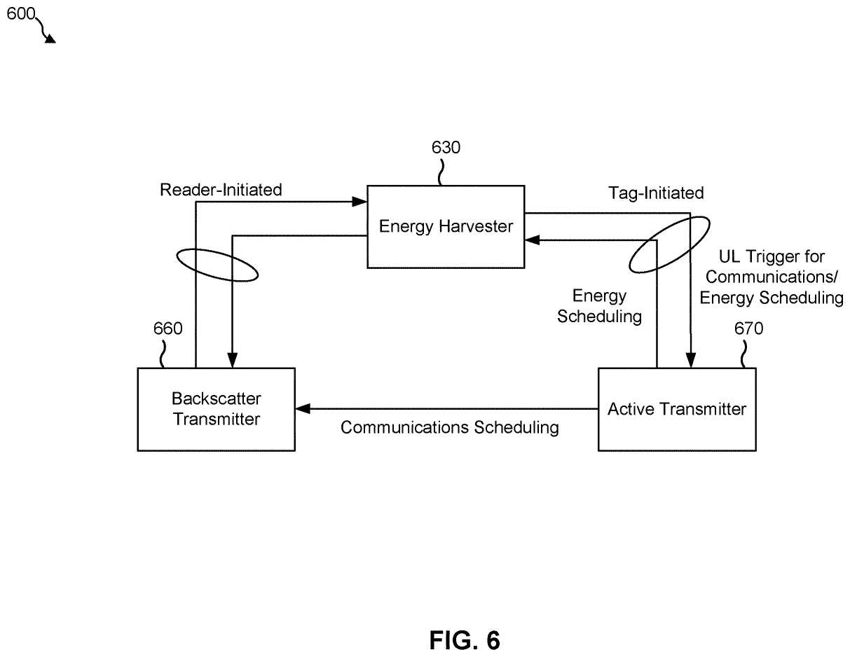

In some aspects, ultra-light IoT devices can include both a backscatter transmitter (e.g., a backscatter radio) and an active transmitter (e.g., an active radio). Ultra-light IoT devices may also be referred to as energy harvesting devices. For example, in some cases an ultra-light IoT device may be implemented as a combination of a passive or semi-passive energy harvesting device and an active energy harvesting device. An example ultra-light IoT device will be described in greater depth below with respect to FIG. 6.

Returning to the discussion of FIG. 5, in examples in which the energy harvesting device 500 is implemented as a passive or semi-passive energy harvesting device, a continuous carrier wave downlink signal may be received using antenna 590 and modulated (e.g., re-modulated) for uplink communication. In some cases, a modulator 560 can be used to modulate the reflected (e.g., backscattered) portion of the downlink signal. For example, the continuous carrier wave may be a continuous sinusoidal wave (e.g., sine or cosine waveform) and modulator 560 can perform modulation based on varying one or more of the amplitude and the phase of the backscattered reflection. Based on modulating the backscattered reflection, modulator 560 can encode digital symbols (e.g., binary symbols or more complex systems of symbols) indicative of an uplink communication. For example, the uplink communication may be indicative of sensor data, control data, or other information associated with the one or more sensors 570 included in energy harvesting device 500.

As mentioned above, impedance matching component 510 can be used to match the impedance of antenna 590 to the receive components of energy harvesting device 500 when receiving the downlink signal (e.g., when receiving the continuous carrier wave). In some examples, during backscatter operation (e.g., when transmitting an uplink signal), modulation can be performed based on intentionally mismatching the antenna input impedance to cause a portion of the incident downlink signal to be scattered back. The phase and amplitude of the backscattered reflection may be determined based on the impedance loading on the antenna 590. Based on varying the antenna impedance (e.g., varying the impedance mismatch between antenna 590 and the remaining components of energy harvesting device 500), digital symbols and/or binary information can be encoded (e.g., modulated) onto the backscattered reflection. Varying the antenna impedance to modulate the phase and/or amplitude of the backscattered reflection can be performed using modulator 560.

As illustrated in FIG. 5, a portion of a downlink signal received using antenna 590 can be provided to a demodulator 520, which performs demodulation and provides a downlink communication (e.g., carried or modulated on the downlink signal) to a processor such as a micro-controller unit (MCU) 550 or another processor included in the energy harvesting device 500. A remaining portion of the downlink signal received using antenna 590 can be provided to energy harvester 530, which harvests RF energy from the downlink signal. For example, energy harvester 530 can harvest RF energy based on performing AC-to-DC (alternating-current-to-direct-current) conversion, wherein an AC current is generated from the sinusoidal carrier wave of the downlink signal and the converted DC current is used to power the energy harvesting device 500. In some aspects, energy harvester 530 can include one or more rectifiers for performing AC-to-DC conversion. A rectifier can include one or more diodes or thin-film transistors (TFTs). In one illustrative example, energy harvester 530 can include one or more Schottky diode-based rectifiers. In some cases, energy harvester 530 can include one or more TFT-based rectifiers.

The output of the energy harvester 530 is a DC current generated from (e.g., harvested from) the portion of the downlink signal provided to the energy harvester 530. In some aspects, the DC current output of energy harvester 530 may vary with the input provided to the energy harvester 530. For example, an increase in the input current to energy harvester 530 can be associated with an increase in the output DC current generated by energy harvester 530. In some cases, MCU 550 may be associated with a band of acceptable DC current values. Regulator 540 can be used to remove or otherwise decrease variation(s) in the DC current generated as output by energy harvester 530. For example, regulator 540 can remove or smooth spikes (e.g., increases) in the DC current output by energy harvester 530 (e.g., such that the DC current provided as input to MCU 550 by regulator 540 remains below a first threshold). In some cases, regulator 540 can remove or otherwise compensate for drops or decreases in the DC current output by energy harvester 530 (e.g., such that the DC current provided as input to MCU 550 by regulator 540 remains above a second threshold).

In some aspects, the harvested DC current (e.g., generated by energy harvester 530 and regulated upward or downward as needed by regulator 540) can be used to power MCU 550 and one or more additional components included in the energy harvesting device 500. For example, the harvested DC current can additionally be used to power one or more (or all) of the impedance matching 510, demodulator 520, regulator 540, MCU 550, sensors 570, modulator 560, and/or other components of the energy harvesting device 500. For example, sensors 570 and modulator 560 can receive at least a portion of the harvested DC current that remains after MCU 550 (e.g., that is not consumed by MCU 550). In some cases, the harvested DC current output by regulator 540 can be provided to MCU 550, modulator 560, and sensors 570 in series, in parallel, or a combination thereof.

In some examples, sensors 570 can be used to obtain sensor data (e.g., sensor data associated with an environment in which the energy harvesting device 500 is located). Sensors 570 can include one or more sensors, which may be of a same type or different types. In some aspects, one or more (or all) of the sensors 570 can be configured to obtain sensor data based on control information included in a downlink signal received using antenna 590. For example, one or more of the sensors 570 can be configured based on a downlink communication obtained based on demodulating a received downlink signal using demodulator 520. In one illustrative example, sensor data can be transmitted based on using modulator 560 to modulate (e.g., vary one or more of amplitude and/or phase of) a backscatter reflection of the continuous carrier wave received at antenna 590. Based on modulating the backscattered reflection, modulator 560 can encode digital symbols (e.g., binary symbols or more complex systems of symbols) indicative of an uplink communication or data message. In some examples, modulator 560 can generate an uplink, backscatter modulated signal based on receiving sensor data directly from sensors 570. In some examples, modulator 560 can generate an uplink, backscatter modulated signal based on received sensor data from MCU 550 (e.g., based on MCU 550 receiving sensor data directly from sensors 570).

As indicated above, FIG. 5 is provided as an example. Other examples may differ from what is described with regard to FIG. 5.

FIG. 6 is a diagram illustrating an example of an ultra-light IoT device 600. Ultra-light IoT device 600 can include an energy harvester 630, which can be used to harvest energy from one or more downlink energy signals (e.g., RF signals) received as input. In some examples, energy harvester 630 can be the same as or similar to energy harvester 530 illustrated in FIG. 5. In some cases, energy harvester 630 can include one or more of the components included in the energy harvesting device 500 illustrated in FIG. 5. For example, energy harvester 630 can include one or more (or all) of the energy harvester 530, regulator 540, boost converter 580, energy storage element(s) 585, etc.

As mentioned above, ultra-light IoT devices (e.g., the ultra-light IoT device 600) can include both a backscatter transmitter (e.g., a backscatter radio) and an active transmitter (e.g., an active radio). For example, ultra-light IoT device 600 includes a backscatter transmitter 660 and an active transmitter 670. In one illustrative example, backscatter transmitter 660 can generate and transmit an uplink signal by reflecting and backscatter modulating an incident downlink signal (e.g., received at energy harvester 630 and subsequently provided to backscatter transmitter 660). Backscatter transmitter 660 can include one or more (or all) of the demodulator 520, modulator 560, antenna 590, MCU 550, etc., illustrated in the energy harvesting device 500 of FIG. 5.

Active transmitter 670 can use a battery or other energy storage element (e.g., the same as or similar to energy storage element 585 illustrated in FIG. 5) included in the ultra-light IoT device 600 to generate and transmit an uplink signal. For example, the ultra-light IoT device 600 can include a battery or other energy storage element, energy harvester 630 can include a battery or other energy storage element, and/or active transmitter 670 can include a battery or other energy storage element, etc.

To transmit an uplink signal, the backscatter transmitter 660 may first receive a downlink signal that can be reflected and backscatter modulated. In some aspects, uplink communication performed using backscatter transmitter 660 can be referred to as “reader-initiated” communications (e.g., based on backscatter transmitter 660 receiving a downlink RF signal from a network device, base station, gNB, or other “reader”). To transmit an uplink signal using active transmitter 670, ultra-light IoT device 600 does not need to receive a corresponding downlink RF signal. Ultra-light IoT device 600 can use active transmitter 670 to perform uplink communication that is triggered by the ultra-light IoT device 600 (e.g., also referred to as “device-initiated” communications, or “tag-initiated” communications in examples where the ultra-light IoT device 600 is implemented as a tag).

In some examples, energy harvester 630 can provide power (e.g., electrical energy or current) to ultra-light IoT device 600 based on performing energy harvesting and/or using one or more batteries or energy storage elements. In one illustrative example, ultra-light IoT device 600 can utilize active transmitter 670 (e.g., and stored energy from a battery or energy storage element) to perform device-initiated communications with a network node (e.g., base station, gNB). In some cases, the device-initiated communication can include or be indicative of an uplink (UL) trigger for communication scheduling and/or for energy scheduling. For example, active transmitter 670 can be used to perform device-initiated communication with a network node to request an energy transmission to be scheduled or performed immediately, to request one or more modifications or updates to the energy signal(s) transmitted from the network node to the ultra-light IoT device 600, etc. In some cases, active transmitter 670 can be used to perform device-initiated communication with a network node to schedule one or more communications between the ultra-light IoT device 600 and the network node.

In one illustrative example, ultra-light IoT device 600 can use active transmitter 670 to schedule an upcoming backscatter modulated communication by the ultra-light IoT device 600. For example, based on a communication scheduling information transmitted via active transmitter 670 of ultra-light IoT device 600, the network node can subsequently transmit a downlink RF signal to the ultra-light IoT device 600 at a scheduled time (e.g., using one or more scheduled time-frequency resources). By using active transmitter 670 to request a downlink RF signal from the network node at a future time, ultra-light IoT device 600 can subsequently use backscatter transmitter 660 to perform scheduled communications with the network node.

In some aspects, ultra-light IoT device 600 can perform backscattering with a frequency shift and/or can perform backscattering without a frequency shift. For example, backscattering without a frequency shift can be performed based on using backscatter transmitter 660 (e.g., and a modulator included in or associated with backscatter transmitter 660) to perform amplitude-shift keying (ASK) modulation and/or phase-shift keying (PSK) modulation of a reflected (e.g., backscattered) downlink RF signal. In some cases, backscattering without a frequency shift may be associated with self-interference. For example, the backscatter modulated signal and the corresponding downlink RF signal used to generate the backscatter modulated signal are transmitted and received, respectively, on the same frequency or frequency band. The backscatter modulated signal and the corresponding downlink RF signal also overlap in time, either partially or wholly (e.g., because the backscatter modulated signal is only generated and transmitted while the corresponding downlink RF signal is being received at the ultra-light IoT device 600).

In one illustrative example, ultra-light IoT device 600 can perform backscattering with one or more frequency shifts. In some aspects, the one or more frequency shifts can be used to implement additional modulation schemes at backscatter transmitter 660 (e.g., modulation schemes other than ASK or PSK). Implementing frequency shifts and/or additional modulation schemes can, in some cases, be associated with increased complexity and/or energy consumption at the ultra-light IoT device 600. For example, a larger frequency shift (e.g., larger Δf) may be associated with a greater energy consumption than a smaller frequency shift (e.g., smaller Δf) or no frequency shift (e.g., zero Δf).

In some aspects, a backscattering frequency shift can be implemented using one or more square waves (e.g., or portions of a square wave). For example, ultra-light IoT device 600 (e.g., and/or other UEs that include a backscatter transmitter) can frequency shift a backscattered signal (e.g., reflected downlink RF signal) using one or more square waves. In one illustrative example, for an incoming signal Sᵢₙ that includes a plurality of symbols, ultra-light IoT device 600 can perform frequency shifting based on combining the symbols included in incoming signal Sᵢₙ that includes a plurality of symbols, or ultra-light IoT device 600 can perform frequency shifting based on combining the symbols included in incoming signal Sᵢₙ with a respective or corresponding square wave (e.g., or portion thereof). For example, an incoming symbol S_{in,0} can be combined with a (square wave)₀, an incoming symbol S_{in,1} can be combined with a (square wave)₁, . . . , and an incoming symbol S_{in,n} can be combined with a (square wave)ₙ. In some cases, a Fourier approximation of a square wave function square(t) used to implement a backscattering frequency shift f_{shift} can be given as:

$$square ( {f}_{shift} t ) = \frac{4}{π} {\sum }_{n = 1 , 3 , 5 , …}^{∞} \frac{1}{n} sin ( 2 π {nf}_{shift} t ) \qquad Eq . ( 1 )$$

As mentioned above, PRACH signals and communications can be used by a UE (e.g., the ultra-light IoT device 600) to align its uplink transmissions to a base station or gNB and gain access to (e.g., connect to) a wireless network associated with the base station or gNB, or to perform other sorts of operations. For example, PRACH signals can be used for initial access requests from a UE to a base station and to obtain time synchronization. To access the network, the UE can request access by transmitting a random access preamble through PRACH signals. The RA preamble can be detected by a PRACH receiver at the base station, which estimates the ID of the transmitted preamble and a propagation delay between the UE and the base station. The base station and UE are then time-synchronized according to a time alignment value (e.g., determined from the propagation delay estimate) transmitted from the base station prior to the uplink transmission.

Based on PRACH configuration information received from the network node (e.g., using active transmitter 670 and/or using backscatter transmitter 660), the ultra-light IoT device 600 can use one or more determined or selected time-frequency resources to transmit a PRACH signal to the network node, based on using backscatter transmitter 660 to backscatter modulate the PRACH signal onto a reflected downlink RF signal received from the network node.

In some aspects, the backscatter modulated PRACH signal can be transmitted using frequency hopping. For example, ultra-light IoT device 600 can use one or more frequency hopping patterns to transmit the backscatter modulated PRACH signal, as will be described in greater depth below.

As indicated above, FIG. 6 is provided as an example. Other examples may differ from what is described with regard to FIG. 6.

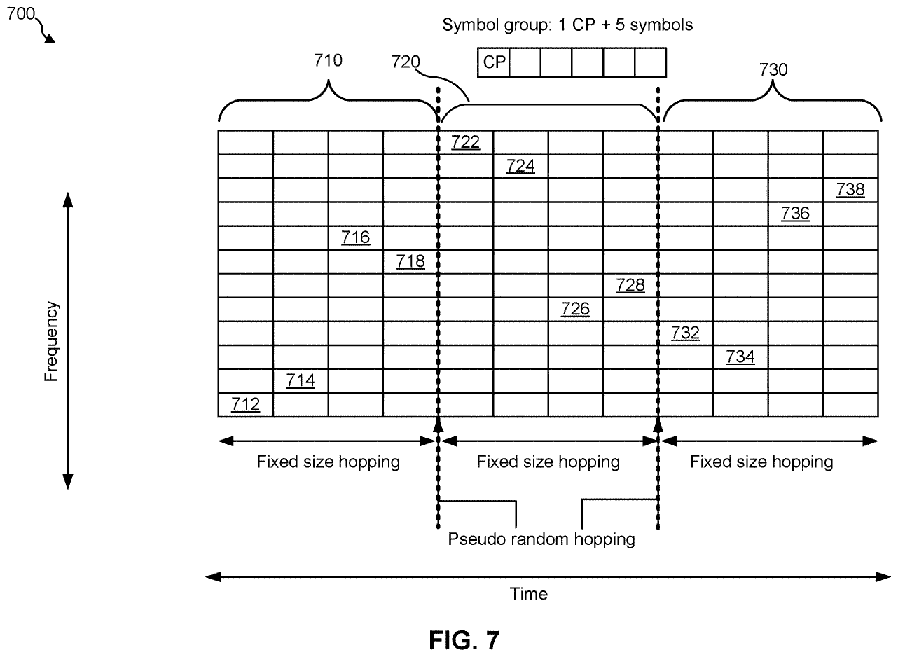

FIG. 7 is a is a diagram illustrating an example PRACH signal transmission using inner layer fixed size frequency hopping and outer layer pseudo-random frequency hopping, in accordance with some examples. A time-frequency grid 700 includes a plurality of time-frequency resources that can be used (e.g., are available) for PRACH transmission. As illustrated, a vertical axis of the time-frequency grid 700 corresponds to frequency (e.g., different frequency resources) and a horizontal axis of the time-frequency grid 700 corresponds to time (e.g., different time resources). Each box within the 12×7 time-frequency grid 700 can be used to transmit one symbol group. In some aspects, each symbol group can include a cyclic prefix (CP) and five symbols.

In the example of FIG. 7, PRACH frequency hopping can be implemented using a frequency hopping pattern involving groups of four consecutive symbol groups. For example, a first group 710 includes symbol groups 712, 714, 716, and 718; a second group 720 includes symbol groups 722, 724, 726, and 728; and a third group 730 includes symbol groups 732, 734, 736, and 738. Inner layer fixed size frequency hopping can be performed by using one or more (e.g., fixed) frequency hopping step sizes within each of the three groups 710, 720, 730. For example, the inner layer fixed size frequency hopping pattern depicted in FIG. 7 is based on a first level single-subcarrier hopping between the first and second symbol groups and between the third and fourth symbol groups included in each of the three groups 710, 720, 730, and a second level six-subcarrier hopping between the second and third symbol groups included in each of the three groups 710, 720, 730.

For example, with respect to the first group 710, a first level single-subcarrier hopping (e.g., hopping step size of one) is performed between first symbol group 712 and second symbol group 714 and is also performed between third symbol group 716 and fourth symbol group 718. A second level six-subcarrier hopping is performed between second symbol group 714 and third symbol group 716.

In some aspects, the two first level single-subcarrier hoppings can be mirrored or reversed relative to one another. For example, if the first single-subcarrier hopping (e.g., from first symbol group 712 to second symbol group 714) is an upward frequency hop, the second single-subcarrier hopping (e.g., from third symbol group 716 to fourth symbol group 718) can be in the opposite direction (e.g., a downward frequency hop). If the first single-subcarrier hopping is a downward frequency hop, the second single-subcarrier frequency hopping can be an upward frequency hop. In some examples, the mirroring or reversal of direction of the first and second single-subcarrier hoppings can be performed based on a cell coverage requirement. For example, the first level hopping may be used to ensure cell coverage, and mirroring of hopping may be used to compensate frequency carrier offset. In some cases, the alternating of upward and downward single-subcarrier hoppings can be extended across the groupings of symbol groups. For example, if the first grouping 710 is associated with an “UP” and a “DOWN” single-subcarrier hopping, second grouping 720 can be associated with an “UP” and a “DOWN” single-subcarrier hopping, third grouping 730 can be associated with an “UP” and a “DOWN” single-subcarrier hopping, etc.

The second level six-subcarrier hopping (e.g., from second symbol group 714 to third symbol group 716) can be used to improve timing estimation accuracy. In some cases, the second level six-subcarrier hopping can be mirrored or reversed in direction for a given two consecutive groupings of four symbol groups (e.g., between group 710 and 720, between group 720 and 730, etc.). For example, the second level six-subcarrier hopping between the second symbol group 714 and third symbol group 716 included in first grouping 710 is an upward frequency hop. The second level six-subcarrier hopping between the second symbol group 724 and third symbol group 726 included in second grouping 720 can be in the opposite direction (e.g., a downward frequency hop). The second level six-subcarrier hopping between the second symbol group 734 and third symbol group 736 included in third grouping 730 can again be in the opposite or reversed direction (e.g., an upward frequency hop).

In some examples, an outer layer pseudorandom frequency hopping step size can be applied between consecutive groups of four symbol groups (e.g., between group 710 and 720, between group 720 and 730, etc.). In one illustrative example, the outer layer pseudorandom frequency hopping step size can be applied between the last (e.g., fourth symbol group) included in the given grouping and the first (e.g., first symbol group) included in the next grouping. For example, an outer layer pseudorandom frequency hopping can be performed between the fourth symbol group 718 included in the first grouping 710 and the first symbol group 722 included in the second grouping 720, can be performed between fourth symbol group 728 included in the second grouping 720 and the first symbol group 732 included in the third grouping 730, etc. In some examples, the outer layer pseudorandom frequency hopping can have a pseudorandom hopping step size and a pseudorandom hopping direction. For example, between first grouping 710 and second grouping 720, the pseudorandom hopping can have a step size of five and a direction of “UP.” Between second grouping 720 and third grouping 730, the pseudorandom hopping can have a step size of two and a direction of “DOWN.”

In some examples, each frequency hopping step associated with a PRACH signal transmission (e.g., the transmission illustrated in the example of FIG. 7) can be given as:

$$s ( t ) = sin ( 2 π {f}_{i} t ) Rect ( t ) \qquad Eq . ( 2 )$$

$$S ( t ) = F ( s ( t ) ) = sin c ( f - {f}_{i} ) - sin c ( f + {f}_{i} ) \qquad Eq . ( 3 )$$

Here, s(t) is a time-domain representation of the backscattered signal transmitted by an ultra-light IoT device (e.g., or other UE with a backscatter transmitter). The sin(2πfᵢt) term in Eq. (2) represents a continuous wave downlink signal received at the ultra-light IoT device. Rect(t) represents a square wave or square wave function applied to frequency shift the continuous wave downlink signal. In Eq. (3), S(f) is a frequency-domain representation of s(t), based on a Fourier transform F (s(t)).

For a signal time duration, t, the bandwidth of S(f) is 2/τ. In some cases, latency can be reduced by choosing a minimum frequency separation based on the time duration t. For example, if the time duration t is less than or equal to one millisecond, then the minimum frequency hopping separation can be Δf_{hop,min}>2 kHz to minimize or eliminate inter-carrier interference. In some aspects, when multiple hopping is utilized, the minimum frequency separation can be lowered.

As indicated above, FIG. 7 is provided as an example. Other examples may differ from what is described with regard to FIG. 7.

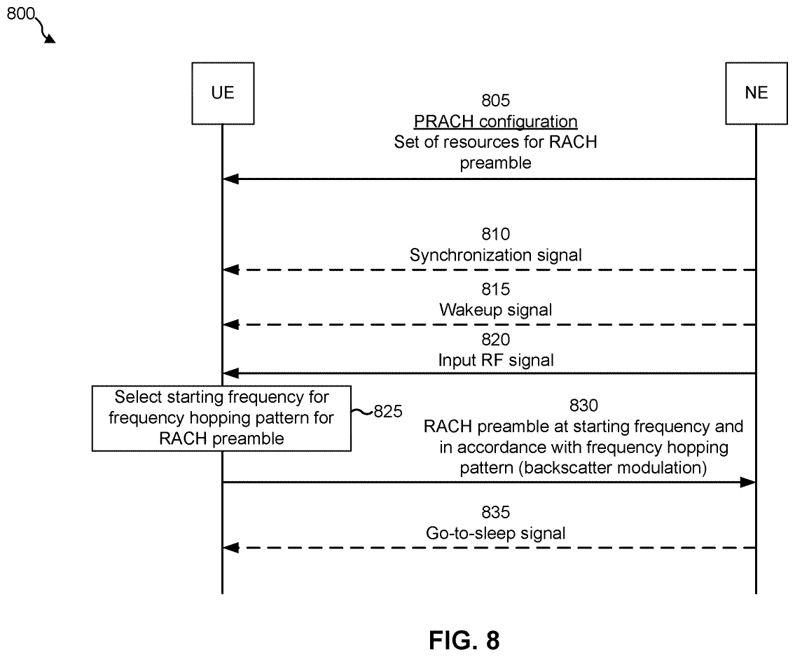

FIG. 8 is a diagram illustrating an example 800 of signaling for PRACH frequency hopping for ultra-light IoT, in accordance with the present disclosure. Example 800 includes a UE (e.g., UE 120, energy harvesting device 500, ultra-light IoT device 600) and a network entity (e.g., BS 110, CU 310, DU 330, RU 340).

As shown by reference number 805, the network entity may output (e.g., transmit or provide to another network entity for transmission), and the UE may receive, a PRACH configuration. For example, the network entity may provide the PRACH configuration using RRC signaling, MAC signaling, DCI, or a combination thereof. In some aspects, the PRACH configuration may include information relating to transmission of a RACH preamble, such as transmission of a RACH preamble using frequency hopping, parameters for a frequency hopping pattern, and/or transmission of a RACH preamble by an ultra-light IoT device.

In some aspects, the set of resources may define a window (e.g., a set of time resources, a set of time and frequency (time-frequency or time-frequency) resources, or a set of frequency resources) in which the UE can transmit a RACH preamble. The frequency hopping pattern may indicate a pattern of resources (e.g., slots, symbols, subcarriers, RACH resources) within the window on which the UE can transmit a RACH preamble. In some aspects, the network entity may indicate a common window (e.g., a common RACH resource) for all UEs (e.g., all ultra-light IoT devices, all UEs covered by the network entity). In some other aspects, the network entity may configure different windows for different UEs. For example, the network entity may divide a resource grid (e.g., a frequency grid, a time/frequency grid) into multiple subsets, and may configure different subsets of the frequency grid for different UEs.

In some aspects, the set of resources comprises a set of frequency resources for the RACH preamble. For example (e.g., in a case in which the UE synchronizes with the network entity prior to transmission of the RACH preamble), the network entity may configure a frequency resource for the RACH preamble. In this case, RACH preamble transmissions may collide with data transmissions. To avoid the collision, the network entity may avoid scheduling data in a frequency range that overlaps with a frequency resource configured for RACH preamble transmission.

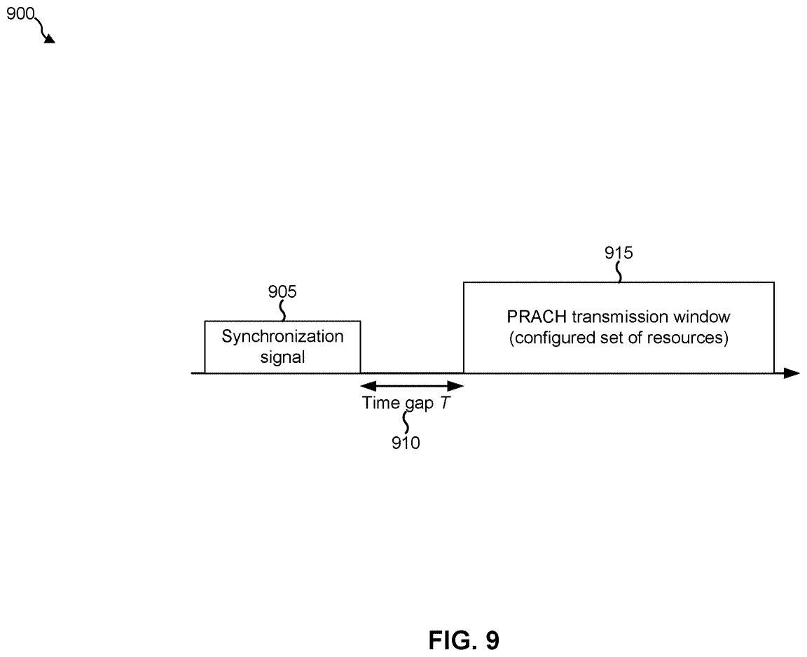

In some aspects, the set of resources comprises a set of time-frequency resources for the RACH preamble. For example, (e.g., in a case in which the UE synchronizes with the network entity prior to transmission of the RACH preamble), the network entity may configure a time-frequency resource (e.g., both a frequency resource and a time duration) for the RACH preamble. In some aspects, the PRACH configuration may indicate a time gap between reception of a synchronization signal and the set of time-frequency resources, as described in connection with FIG. 9 below.

In some aspects, the set of resources may include a predefined resource. For example (e.g., in a case in which the UE does not perform synchronization with the network entity, such as after waking up from a sleep state such as a long sleep), the set of resources may be defined by a wireless communication specification (e.g., prior to establishing an RRC configuration or receiving a wakeup signal or other signaling from the network entity), which reduces overhead and processing and eliminates the need for synchronization to locate the set of resources.

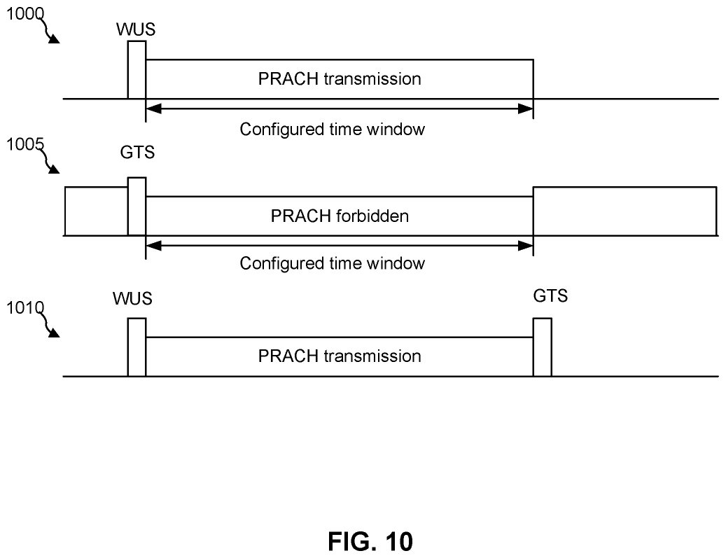

In some aspects, the PRACH configuration, or a configuration or other signaling received separately from the PRACH configuration, may indicate one or more parameters for a wakeup signal (e.g., a group-based wakeup signal) or a go-to-sleep signal (e.g., a group-based go-to-sleep signal). A wakeup signal is a signal that indicates a set of resources for transmission of a RACH preamble, such as based on a configuration indicating a time and/or frequency relationship between the wakeup signal and the set of resources. A go-to-sleep signal is a signal that indicates that a set of resources are unavailable for RACH preamble transmission, that indicates an end of a set of resources for RACH preamble transmission, or that indicates to cease RACH preamble transmission. The usage of one or more of the wakeup signal or the go-to-sleep signal may indicate available (or unavailable) PRACH resources, which may reduce power consumption and processing overhead of the UE. Furthermore, the usage of the wakeup signal or the go-to-sleep signal may enable identification of the set of resources for RACH preamble transmission without performing synchronization, thereby reducing overhead and delay associated with RACH preamble transmission. The wakeup signal and the go-to-sleep signal are described in more detail in connection with FIG. 10.

As mentioned, in some aspects, the PRACH configuration or other signaling may indicate one or more parameters for a wakeup signal, including at least one of a periodicity of the wakeup signal, a frequency location of the wakeup signal, or a duration of a time window for transmission of the RACH preamble (e.g., the duration of the set of resources indicated by the PRACH configuration). Additionally, or alternatively, the PRACH configuration may indicate one or more parameters for the go-to-sleep signal, which may include at least one of a periodicity of the go-to-sleep signal, a frequency location of the go-to-sleep signal, or a duration of a time window in which transmission of the RACH preamble is forbidden. In some other aspects, one or more parameters of the wakeup signal or the go-to-sleep signal, such as one or more of the parameters described above as being configured, may be preconfigured (e.g., indicated in a wireless communication specification).

In some aspects, a synchronization signal (for example, the synchronization signal of FIG. 9) may indicate the set of resources for the RACH preamble. For example, the synchronization signal may include information indicating the set of resources. The UE may receive the synchronization signal prior to entering a sleep state. Therefore, in some examples, timing and frequency information at the UE may drift during the sleep state. The UE may transmit the RACH preamble after exiting the sleep state.

In some aspects, the UE may perform continuous frequency hopping, such that the set of resources on which the RACH preamble is transmitted includes a set of contiguous time resources (e.g., without a time gap between hops of the frequency hopping pattern). Continuous frequency hopping may reduce latency and resource usage of RACH transmission, and may be beneficial for UEs that have a threshold clock stability and can switch transmission frequencies quickly enough to perform continuous frequency hopping. In some aspects, the UE may perform continuous frequency hopping based at least in part on the UE having a threshold clock stability and being capable of switching transmission frequencies quickly enough to perform continuous frequency hopping.

In some aspects, the UE may perform frequency hopping with a time gap between hops. For example, the frequency hopping pattern (or the PRACH configuration) may indicate a time gap between hops of the frequency hopping pattern. In this example, the set of resources may include a first time resource and a second time resource that is separated from the first time resource in time. The time gap may provide time for a UE to switch frequencies (e.g., a warm-up duration), which may enable frequency switching for UEs that are not capable of performing continuous frequency hopping due to a limitation in a frequency switching capability of the UE. Additionally, the time gap may reduce collision between RACH preamble transmissions of different UEs which may have different local clock times (for example, due to having low clock stability), thereby reducing inter-UE interference.

In some aspects, the PRACH configuration indicates a length of the frequency hopping pattern. For example, the network entity may configure different UEs (e.g., different groups of UEs) with different lengths for a frequency hopping pattern (e.g., the frequency hopping pattern of FIG. 7). A frequency hopping pattern with a greater length may have longer individual frequency hops. By configuring different lengths of frequency hopping pattern, the network entity can differentiate which UE is transmitting a RACH preamble according to the length of a frequency hop of the RACH preamble. In one example, a higher priority group of UEs may be configured with a longer frequency hopping pattern, and a lower priority group of UEs may be configured with a shorter frequency hopping pattern. Thus, the length of the frequency hopping pattern is associated with a group (e.g., a group of UEs) indicated by the PRACH configuration.

As shown by reference number 810, in some examples, the network entity may transmit or cause transmission of, and the UE may receive, a synchronization signal. The synchronization signal is described in more detail in connection with FIG. 9.

As shown by reference number 815, in some examples, the network entity may transmit or cause transmission of, and the UE may receive, a wakeup signal. The wakeup signal is described in more detail in connection with FIG. 10.

As shown by reference number 820, the network entity may transmit or cause transmission of, and the UE may receive, an input RF signal. The input RF signal may include a signal from which the UE can harvest energy for transmission of the RACH preamble.

As shown by reference number 825, the UE may select a starting frequency for a frequency hopping pattern for transmission of a RACH preamble. For example, the frequency hopping pattern may be defined relative to the starting frequency, such that the UE's transmission of the RACH preamble hops from a first resource at the starting frequency to a second resource that is at a frequency offset defined relative to the starting frequency of the first resource. In FIG. 7, the starting resource is shown by symbol group 712.

In some aspects, the UE may select the starting frequency based at least in part on a random function or a hash. For example, the hash may use, as an input, an identifier of the UE. Selecting based at least in part on the random function or the hash may conserve resources of the UE that would otherwise be used to sense a frequency grid.

In some aspects, the UE may perform sensing of a plurality of frequencies. For example, the UE may sense frequencies of a frequency grid (such as time-frequency grid 700). The frequencies may include, for example, a set of subcarriers of the set of resources indicated by the PRACH configuration. The sensing may include, for example, determining a measurement value (e.g., a reference signal received power, a signal-to-interference-plus-noise ratio (SINR), or the like). The UE may select the starting frequency based at least in part on the sensing, as described below. In some aspects, the UE may sense each frequency of the frequency grid. For example, the UE may sense each subcarrier included in the set of resources, and may select a starting frequency as a subcarrier with a most favorable measurement value (e.g., a measurement value indicating that the subcarrier is associated with low interference, such as a lowest SINR) or a subcarrier with a measurement value that satisfies a threshold. For example, the UE may select the starting frequency based at least in part on the starting frequency having a lowest interference value of interference values of the plurality of frequencies. As another example, the UE may select, from starting frequencies having interference values lower than a threshold, a starting frequency (e.g., randomly, in accordance with a rule). In this example, the UE may select the starting frequency based at least in part on a threshold and an interference value.

In some aspects, the UE may select the starting frequency based at least in part on a group indicated by the PRACH configuration. For example, a group of UEs may be mapped, by the PRACH configuration, to a starting frequency in the set of resources. Different groups of UEs may be mapped to different starting frequencies.

As shown by reference number 830, the UE may transmit, and the network entity may obtain (e.g., receive from the UE, receive from another network entity), the RACH preamble. The UE's transmission of the RACH preamble may be in accordance with the frequency hopping pattern. For example, the UE's transmission of the RACH preamble may occupy time and frequency resources defined by the frequency hopping pattern. Furthermore, the UE's transmission of the RACH preamble may be at the starting frequency. For example, the starting frequency may be used to initiate the frequency hopping pattern, and the frequency hopping pattern may identify time and/or frequency resources for one or more frequency hops subsequent to an initial transmission of the frequency hopping pattern. The UE may transmit the initial transmission and the one or more frequency hops as indicated by the frequency hopping pattern. For example, the UE may perform backscatter modulation, using energy harvested from the input RF signal, to transmit the RACH preamble.

As shown by reference number 835, in some examples, the network entity may transmit or cause transmission of, and the UE may receive, a go-to-sleep signal. The go-to-sleep signal is described in more detail in connection with FIG. 10.

As indicated above, FIG. 8 is provided as an example. Other examples may differ from what is described with regard to FIG. 8.

FIG. 9 is a diagram illustrating an example 900 of synchronization prior to transmission of a RACH preamble using backscatter modulation, in accordance with the present disclosure. In example 900, the network entity may transmit or cause to be transmitted, and the UE may receive, a synchronization signal 905. The UE may synchronize with the network entity using the synchronization signal 905. For example, the UE may derive a clock timing of the UE from the synchronization signal 905. Additionally, or alternatively, the UE may synchronize (e.g., synchronize a local oscillator) to a transmission and/or reception frequency derived from the synchronization signal 905. The synchronization signal 905 may include any form of signal. As shown by reference number 910, in some aspects, the UE may identify a set of resources 915 for the RACH preamble based at least in part on a time gap (T) between the synchronization signal 905 and the set of resources 915. In some aspects, a PRACH configuration of the UE may indicate the time gap.

As indicated above, FIG. 9 is provided as an example. Other examples may differ from what is described with regard to FIG. 9.

FIG. 10 is a diagram illustrating examples 1000, 1005, and 1010 of wakeup signaling and go-to-sleep signaling for RACH preamble transmission using backscatter modulation, in accordance with the present disclosure.

In example 1000, the UE receives a wakeup signal (WUS) prior to transmitting a RACH preamble. The UE may receive the WUS according to one or more parameters of the WUS, such as a periodicity and/or a frequency location of the WUS. In some aspects, the WUS may be a group-based WUS directed to a group of UEs including the UE. In some aspects, the UE may identify a set of resources for RACH preamble transmission (shown as “configured time window”) according to the WUS. For example, a parameter may indicate a length of the set of resources corresponding to the WUS. Thus, the time window (i.e., the set of resources) may be related to the WUS. In example 1005, the UE receives a go-to-sleep signal (GTS). The GTS may indicate a set of resources on which RACH preamble transmission is forbidden (e.g., not allowed, not permitted, preempted, precluded). Thus, the UE may refrain from transmitting the RACH preamble during the set of resources. In some aspects, the UE may receive the GTS based at least in part on one or more parameters configured for the GTS, such as a periodicity and/or a frequency location. In some aspects, a length of the set of resources on which RACH preamble transmission may be indicated by a parameter, as described elsewhere herein. In example 1010, the UE receives both a WUS (as in example 1000) and a GTS (as in example 1005).

As indicated above, FIG. 10 is provided as an example. Other examples may differ from what is described with regard to FIG. 10.

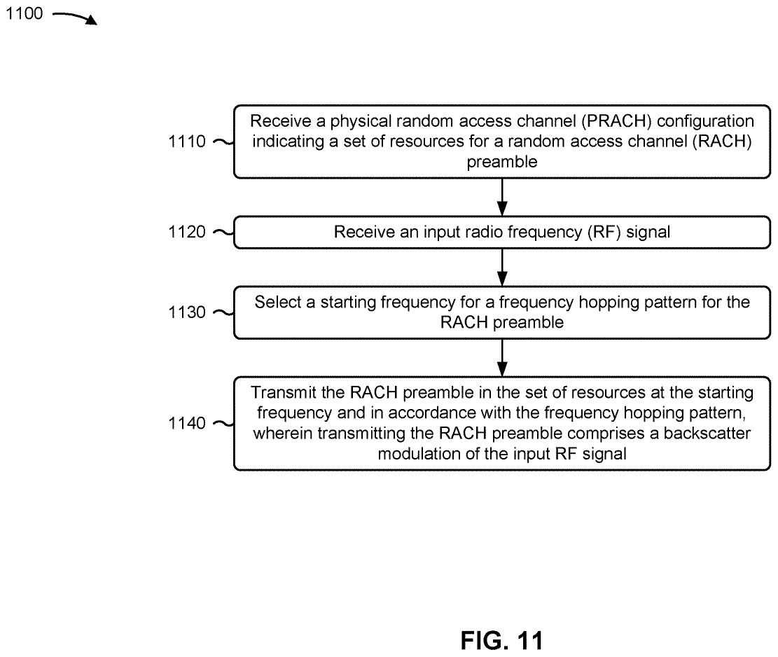

FIG. 11 shows a method 1100 for wireless communications by a UE, such as UE 120.

Method 1100 begins at 1110 with receiving a physical random access channel (PRACH) configuration indicating a set of resources for a random access channel (RACH) preamble.

Method 1100 then proceeds to step 1120 with receiving an input radio frequency (RF) signal.

Method 1100 then proceeds to step 1130 with selecting a starting frequency for a frequency hopping pattern for the RACH preamble.

Method 1100 then proceeds to step 1140 with transmitting the RACH preamble in the set of resources at the starting frequency and in accordance with the frequency hopping pattern, wherein transmitting the RACH preamble comprises a backscatter modulation of the input RF signal.

In a first aspect, the set of resources comprises a set of frequency resources for the RACH preamble.

In a second aspect, alone or in combination with the first aspect, the set of resources comprises a set of time-frequency resources for the RACH preamble.

In a third aspect, alone or in combination with one or more of the first and second aspects, the PRACH configuration indicates a time gap between reception of a synchronization signal and the set of time-frequency resources.

In a fourth aspect, alone or in combination with one or more of the first through third aspects, the set of resources comprises a predefined resource.

In a fifth aspect, alone or in combination with one or more of the first through fourth aspects, method 1100 includes receiving a wakeup signal prior to transmitting the RACH preamble, wherein transmitting the RACH preamble comprises transmitting the RACH preamble based at least in part on the wakeup signal.

In a sixth aspect, alone or in combination with one or more of the first through fifth aspects, the PRACH configuration indicates one or more parameters for the wakeup signal.

In a seventh aspect, alone or in combination with one or more of the first through sixth aspects, the one or more parameters include at least one of a periodicity of the wakeup signal, a frequency location of the wakeup signal, or a duration of a time window for transmission of the RACH preamble.

In an eighth aspect, alone or in combination with one or more of the first through seventh aspects, transmitting the RACH preamble based at least in part on the wakeup signal further comprises transmitting the RACH preamble in a time window related to the wakeup signal.

In a ninth aspect, alone or in combination with one or more of the first through eighth aspects, method 1100 includes receiving a go-to-sleep signal, and refraining from transmitting the RACH preamble during a time period related to the go-to-sleep signal.

In a tenth aspect, alone or in combination with one or more of the first through ninth aspects, the PRACH configuration indicates one or more parameters for the go-to-sleep signal.

In an eleventh aspect, alone or in combination with one or more of the first through tenth aspects, the one or more parameters include at least one of a periodicity of the go-to-sleep signal, a frequency location of the go-to-sleep signal, or a duration of a time window for transmission of the RACH preamble.

In a twelfth aspect, alone or in combination with one or more of the first through eleventh aspects, receiving the PRACH configuration further comprises receiving the PRACH configuration prior to entering a sleep mode, and transmitting the RACH preamble further comprises transmitting the RACH preamble after exiting the sleep mode.

In a thirteenth aspect, alone or in combination with one or more of the first through twelfth aspects, selecting the starting frequency comprises selecting the starting frequency based at least in part on a random function or a hash.

In a fourteenth aspect, alone or in combination with one or more of the first through thirteenth aspects, method 1100 includes selecting the starting frequency based at least in part on the sensing.

In a fifteenth aspect, alone or in combination with one or more of the first through fourteenth aspects, selecting the starting frequency based at least in part on the sensing further comprises selecting the starting frequency in accordance with an interference threshold.

In a sixteenth aspect, alone or in combination with one or more of the first through fifteenth aspects, selecting the starting frequency based at least in part on the sensing further comprises selecting the starting frequency based at least in part on the starting frequency having a lowest interference value of interference values of the plurality of frequencies.

In a seventeenth aspect, alone or in combination with one or more of the first through sixteenth aspects, selecting the starting frequency based at least in part on the sensing further comprises selecting the starting frequency in accordance with an interference threshold and based at least in part on an interference value of the starting frequency.

In an eighteenth aspect, alone or in combination with one or more of the first through seventeenth aspects, selecting the starting frequency comprises selecting the starting frequency based at least in part on a group indicated by the PRACH configuration.

In a nineteenth aspect, alone or in combination with one or more of the first through eighteenth aspects, the set of resources includes a first time resource and a second time resource contiguous with the first time resource.

In a twentieth aspect, alone or in combination with one or more of the first through nineteenth aspects, the set of resources includes a first time resource and a second time resource that is separated from the first time resource in time.

In a twenty-first aspect, alone or in combination with one or more of the first through twentieth aspects, the PRACH configuration indicates a length of the frequency hopping pattern.

In a twenty-second aspect, alone or in combination with one or more of the first through twenty-first aspects, the length of the frequency hopping pattern is associated with a group indicated by the PRACH configuration.

In a twenty-third aspect, alone or in combination with one or more of the first through twenty-second aspects, transmitting the RACH preamble further comprises transmitting the RACH preamble without having performed time synchronization after exiting a sleep mode.

In a twenty-fourth aspect, alone or in combination with one or more of the first through twenty-third aspects, transmitting the RACH preamble further comprises transmitting the RACH preamble without having performed time synchronization or frequency synchronization after exiting a sleep mode.

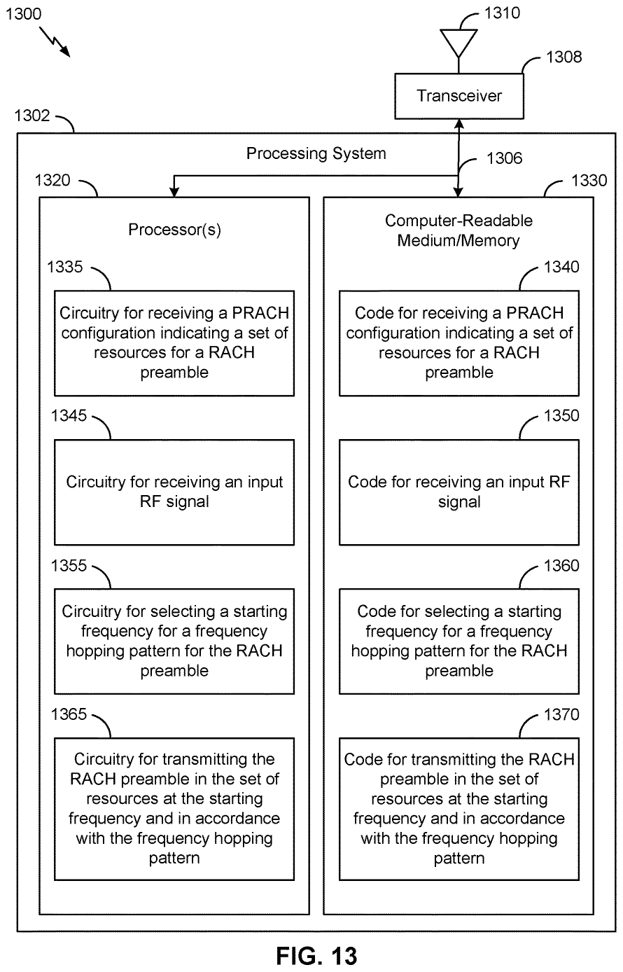

In one aspect, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative steps are possible consistent with this disclosure.

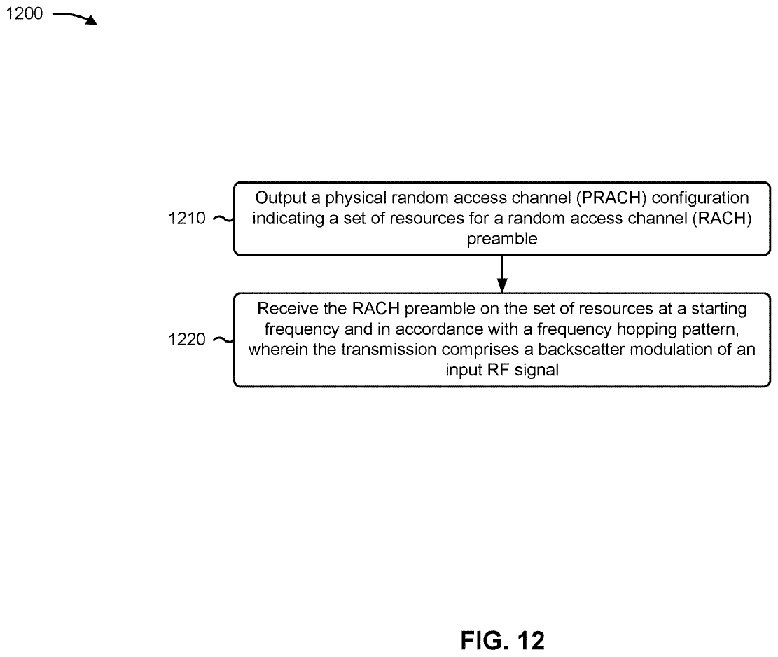

FIG. 12 shows a method 1200 for wireless communications by a network entity, such as BS 110, or a disaggregated base station as discussed with respect to FIG. 3.

Method 1200 begins at 1210 with outputting a PRACH configuration indicating a set of resources for a RACH preamble.

Method 1200 then proceeds to step 1220 with receiving the RACH preamble on the set of resources at a starting frequency and in accordance with a frequency hopping pattern, wherein the transmission comprises a backscatter modulation of an input RF signal.

In a first aspect, the set of resources comprises a set of frequency resources for the RACH preamble.

In a second aspect, alone or in combination with the first aspect, the set of resources comprises a set of time-frequency resources for the RACH preamble.

In a third aspect, alone or in combination with one or more of the first and second aspects, the PRACH configuration indicates a time gap between reception of a synchronization signal and the set of time-frequency resources.

In a fourth aspect, alone or in combination with one or more of the first through third aspects, the set of resources comprises a predefined resource.

In a fifth aspect, alone or in combination with one or more of the first through fourth aspects, method 1200 includes outputting a wakeup signal prior to receiving the RACH preamble, wherein receiving the RACH preamble comprises receiving the RACH preamble based at least in part on the wakeup signal.

In a sixth aspect, alone or in combination with one or more of the first through fifth aspects, the PRACH configuration indicates one or more parameters for the wakeup signal.

In a seventh aspect, alone or in combination with one or more of the first through sixth aspects, the one or more parameters include at least one of a periodicity of the wakeup signal, a frequency location of the wakeup signal, or a duration of a time window for transmission of the RACH preamble.

In an eighth aspect, alone or in combination with one or more of the first through seventh aspects, receiving the RACH preamble based at least in part on the wakeup signal further comprises receiving the RACH preamble in a time window related to the wakeup signal.

In a ninth aspect, alone or in combination with one or more of the first through eighth aspects, method 1200 includes outputting a go-to-sleep signal.

In a tenth aspect, alone or in combination with one or more of the first through ninth aspects, the PRACH configuration indicates one or more parameters for the go-to-sleep signal.

In an eleventh aspect, alone or in combination with one or more of the first through tenth aspects, the one or more parameters include at least one of a periodicity of the go-to-sleep signal, a frequency location of the go-to-sleep signal, or a duration of a time window for transmission of the RACH preamble.

In a twelfth aspect, alone or in combination with one or more of the first through eleventh aspects, the starting frequency is based at least in part on a random function or a hash.

In a thirteenth aspect, alone or in combination with one or more of the first through twelfth aspects, the starting frequency is based at least in part on a UE sensing a plurality of frequencies.

In a fourteenth aspect, alone or in combination with one or more of the first through thirteenth aspects, the starting frequency is based at least in part on an interference threshold.

In a fifteenth aspect, alone or in combination with one or more of the first through fourteenth aspects, the starting frequency is based at least in part on the starting frequency having a lowest interference value of interference values of a plurality of frequencies.

In a sixteenth aspect, alone or in combination with one or more of the first through fifteenth aspects, the starting frequency is based at least in part on an interference threshold and an interference value of the starting frequency.

In a seventeenth aspect, alone or in combination with one or more of the first through sixteenth aspects, the starting frequency is based at least in part on a group indicated by the PRACH configuration.

In an eighteenth aspect, alone or in combination with one or more of the first through seventeenth aspects, the set of resources includes a first time resource and a second time resource contiguous with the first time resource.

In a nineteenth aspect, alone or in combination with one or more of the first through eighteenth aspects, the set of resources includes a first time resource and a second time resource that is separated from the first time resource in time.

In a twentieth aspect, alone or in combination with one or more of the first through nineteenth aspects, the PRACH configuration indicates a length of the frequency hopping pattern.

In a twenty-first aspect, alone or in combination with one or more of the first through twentieth aspects, the length of the frequency hopping pattern is associated with a group indicated by the PRACH configuration.

In a twenty-second aspect, alone or in combination with one or more of the first through twenty-first aspects, receiving the RACH preamble further comprises receiving the RACH preamble without having performed time synchronization with a UE after a sleep mode of the UE.

In a twenty-third aspect, alone or in combination with one or more of the first through twenty-second aspects, receiving the RACH preamble further comprises receiving the RACH preamble without having performed time synchronization or frequency synchronization with a UE after a sleep mode of the UE.

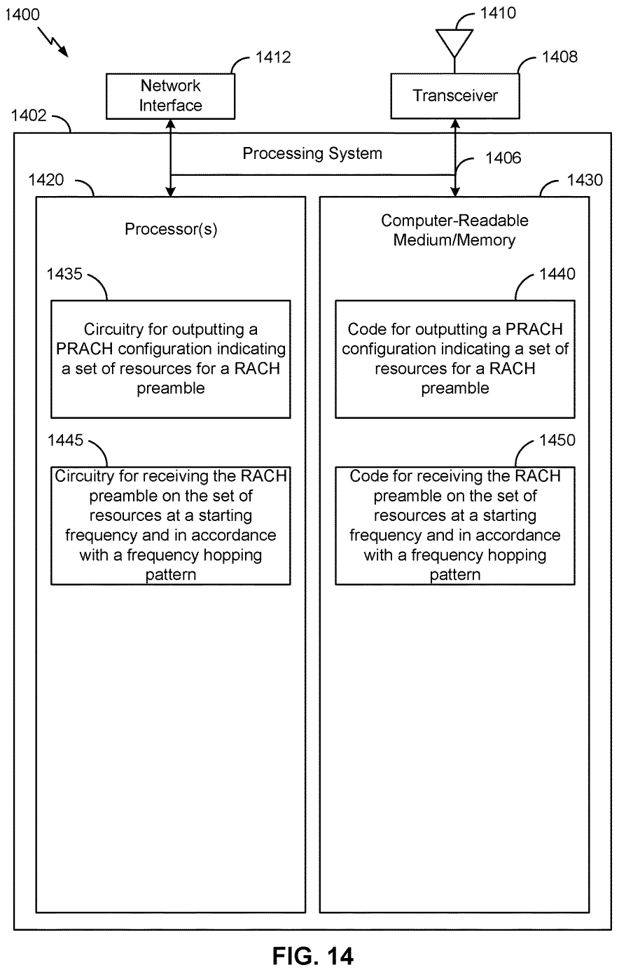

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

FIG. 13 is a diagram illustrating an example of an implementation of code and circuitry for a communications device 1300, in accordance with the present disclosure. The communications device 1300 may be a UE, or a UE may include the communications device 1300.

The communications device 1300 includes a processing system 1302 coupled to a transceiver 1308 (e.g., a transmitter and/or a receiver). The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes one or more processors 1320. In various aspects, the one or more processors 1320 may be representative of one or more of receive processor 258, transmit processor 264, TX MIMO processor 266, and/or controller/processor 280, as described with respect to FIG. 2. The one or more processors 1320 are coupled to a computer-readable medium/memory 1330 via a bus 1306. In various aspects, the computer-readable medium/memory 1330 may be representative of memory 282, as described with respect to FIG. 2. In certain aspects, the computer-readable medium/memory 1330 is configured to store instructions (e.g., computer-executable code, processor-executable code) that when executed by the one or more processors 1320, cause the one or more processors 1320 to perform the method 1100 described with respect to FIG. 11, or any aspect related to it. Note that reference to a processor performing a function of communications device 1300 may include one or more processors performing that function of communications device 1300.

As shown in FIG. 13, the communications device 1300 may include circuitry for receiving a PRACH configuration indicating a set of resources for a RACH preamble (circuitry 1335).

As shown in FIG. 13, the communications device 1300 may include, stored in computer-readable medium/memory 1330, code for receiving a PRACH configuration indicating a set of resources for a RACH preamble (code 1340).

As shown in FIG. 13, the communications device 1300 may include circuitry for receiving an input RF signal (circuitry 1345).

As shown in FIG. 13, the communications device 1300 may include, stored in computer-readable medium/memory 1330, code for receiving an input RF signal (code 1350).

As shown in FIG. 13, the communications device 1300 may include circuitry for selecting a starting frequency for a frequency hopping pattern for the RACH preamble (circuitry 1355).

As shown in FIG. 13, the communications device 1300 may include, stored in computer-readable medium/memory 1330, code for selecting a starting frequency for a frequency hopping pattern for the RACH preamble (code 1360).

As shown in FIG. 13, the communications device 1300 may include circuitry for transmitting the RACH preamble in the set of resources at the starting frequency and in accordance with the frequency hopping pattern, wherein transmitting the RACH preamble comprises a backscatter modulation of the input RF signal (circuitry 1365).

As shown in FIG. 13, the communications device 1300 may include, stored in computer-readable medium/memory 1330, code for transmitting the RACH preamble in the set of resources at the starting frequency and in accordance with the frequency hopping pattern, wherein transmitting the RACH preamble comprises a backscatter modulation of the input RF signal (code 1370).

Various components of the communications device 1300 may provide means for performing the method 1100 described with respect to FIG. 11, or any aspect related to it. For example, means for transmitting, sending, or outputting for transmission may include the transceiver(s) 254 and/or antenna(s) 252 of the UE 120 and/or transceiver 1308 and antenna 1310 of the communications device 1300 in FIG. 13. Means for receiving or obtaining may include the transceiver(s) 254 and/or antenna(s) 252 of the UE 120 and/or transceiver 1308 and antenna 1310 of the communications device 1300 in FIG. 13.

FIG. 13 is provided as an example. Other examples may differ from what is described in connection with FIG. 13.

FIG. 14 is a diagram illustrating an example of an implementation of code and circuitry for a communications device 1400, in accordance with the present disclosure. The communications device 1400 may be a network entity (such as BS 110 or a disaggregated base station as described with regard to FIG. 3), or a network entity may include the communications device 1400.

The communications device 1400 includes a processing system 1402 coupled to a transceiver 1408 (e.g., a transmitter and/or a receiver). The transceiver 1408 is configured to transmit and receive signals for the communications device 1400 via an antenna 1410, such as the various signals as described herein. The network interface 1412 is configured to obtain and send signals for the communications device 1400 via communications link(s), such as a backhaul link, midhaul link, and/or fronthaul link as described herein, such as with respect to FIG. 3. The processing system 1402 may be configured to perform processing functions for the communications device 1400, including processing signals received and/or to be transmitted by the communications device 1400.

The processing system 1402 includes one or more processors 1420. In various aspects, the one or more processors 1420 may be representative of one or more of receive processor 238, transmit processor 220, TX MIMO processor 230, and/or controller/processor 240, as described with respect to FIG. 2. The one or more processors 1420 are coupled to a computer-readable medium/memory 1430 via a bus 1406. In various aspects, the computer-readable medium/memory 1430 may be representative of memory 242, as described with respect to FIG. 2. In certain aspects, the computer-readable medium/memory 1430 is configured to store instructions (e.g., computer-executable code, processor-executable code) that when executed by the one or more processors 1420, cause the one or more processors 1420 to perform the method 1200 described with respect to FIG. 12, or any aspect related to it. Note that reference to a processor performing a function of communications device 1400 may include one or more processors performing that function of communications device 1400.

As shown in FIG. 14, the communications device 1400 may include circuitry for outputting a PRACH configuration indicating a set of resources for a RACH preamble (circuitry 1435).

As shown in FIG. 14, the communications device 1400 may include, stored in computer-readable medium/memory 1430, code for outputting a PRACH configuration indicating a set of resources for a RACH preamble (code 1440).

As shown in FIG. 14, the communications device 1400 may include circuitry for receiving the RACH preamble on the set of resources at a starting frequency and in accordance with a frequency hopping pattern, wherein the transmission comprises a backscatter modulation of an input RF signal (circuitry 1445).

As shown in FIG. 14, the communications device 1400 may include, stored in computer-readable medium/memory 1430, code for receiving the RACH preamble on the set of resources at a starting frequency and in accordance with a frequency hopping pattern, wherein the transmission comprises a backscatter modulation of an input RF signal (code 1450).

Various components of the communications device 1400 may provide means for performing the method 1100 described with respect to FIG. 12, or any aspect related to it. For example, means for transmitting, sending, or outputting for transmission may include the transceiver(s) 232 and/or antenna(s) 234 of the BS 110 and/or transceiver 1408 and antenna 1410 of the communications device 1400 in FIG. 14. Means for receiving or obtaining may include the transceiver(s) 232 and/or antenna(s) 234 of the BS 110 and/or transceiver 1408 and antenna 1410 of the communications device 1400 in FIG. 14.

FIG. 14 is provided as an example. Other examples may differ from what is described in connection with FIG. 14.

The following provides an overview of some Aspects of the present disclosure:

Aspect 1: A method of wireless communication performed by a user equipment (UE), comprising: receiving a physical random access channel (PRACH) configuration indicating a set of resources for a random access channel (RACH) preamble; receiving an input radio frequency (RF) signal; selecting a starting frequency for a frequency hopping pattern for the RACH preamble; and transmitting the RACH preamble in the set of resources at the starting frequency and in accordance with the frequency hopping pattern, wherein transmitting the RACH preamble comprises a backscatter modulation of the input RF signal.

Aspect 2: The method of Aspect 1, wherein the set of resources comprises a set of frequency resources for the RACH preamble.

Aspect 3: The method of any of Aspects 1-2, wherein the set of resources comprises a set of time-frequency resources for the RACH preamble.

Aspect 4: The method of Aspect 3, wherein the PRACH configuration indicates a time gap between reception of a synchronization signal and the set of time-frequency resources.

Aspect 5: The method of any of Aspects 1-4, wherein the set of resources comprises a predefined resource.

Aspect 6: The method of any of Aspects 1-5, further comprising receiving a wakeup signal prior to transmitting the RACH preamble, wherein transmitting the RACH preamble comprises transmitting the RACH preamble based at least in part on the wakeup signal.

Aspect 7: The method of Aspect 6, wherein the PRACH configuration indicates one or more parameters for the wakeup signal.

Aspect 8: The method of Aspect 7, wherein the one or more parameters include at least one of: a periodicity of the wakeup signal, a frequency location of the wakeup signal, or a duration of a time window for transmission of the RACH preamble.

Aspect 9: The method of Aspect 6, wherein transmitting the RACH preamble based at least in part on the wakeup signal further comprises transmitting the RACH preamble in a time window related to the wakeup signal.

Aspect 10: The method of any of Aspects 1-9, further comprising: receiving a go-to-sleep signal; and refraining from transmitting the RACH preamble during a time period related to the go-to-sleep signal.

Aspect 11: The method of Aspect 10, wherein the PRACH configuration indicates one or more parameters for the go-to-sleep signal.

Aspect 12: The method of Aspect 11, wherein the one or more parameters include at least one of: a periodicity of the go-to-sleep signal, a frequency location of the go-to-sleep signal, or a duration of a time window for transmission of the RACH preamble.

Aspect 13: The method of any of Aspects 1-12, wherein receiving the PRACH configuration further comprises receiving the PRACH configuration prior to entering a sleep mode, and wherein transmitting the RACH preamble further comprises transmitting the RACH preamble after exiting the sleep mode.

Aspect 14: The method of any of Aspects 1-13, wherein selecting the starting frequency comprises selecting the starting frequency based at least in part on a random function or a hash.

Aspect 15: The method of any of Aspects 1-14, further comprising performing sensing of a plurality of frequencies, wherein selecting the starting frequency further comprises selecting the starting frequency based at least in part on the sensing.

Aspect 16: The method of Aspect 15, wherein selecting the starting frequency based at least in part on the sensing further comprises selecting the starting frequency in accordance with an interference threshold.

Aspect 17: The method of Aspect 15, wherein selecting the starting frequency based at least in part on the sensing further comprises selecting the starting frequency based at least in part on the starting frequency having a lowest interference value of interference values of the plurality of frequencies.

Aspect 18: The method of Aspect 15, wherein selecting the starting frequency based at least in part on the sensing further comprises selecting the starting frequency in accordance with an interference threshold and based at least in part on an interference value of the starting frequency.

Aspect 19: The method of any of Aspects 1-18, wherein selecting the starting frequency comprises selecting the starting frequency based at least in part on a group indicated by the PRACH configuration.

Aspect 20: The method of any of Aspects 1-19, wherein the set of resources includes a first time resource and a second time resource contiguous with the first time resource.

Aspect 21: The method of any of Aspects 1-20, wherein the set of resources includes a first time resource and a second time resource that is separated from the first time resource in time.

Aspect 22: The method of any of Aspects 1-21, wherein the PRACH configuration indicates a length of the frequency hopping pattern.

Aspect 23: The method of Aspect 22, wherein the length of the frequency hopping pattern is associated with a group indicated by the PRACH configuration.

Aspect 24: The method of any of Aspects 1-23, wherein transmitting the RACH preamble further comprises transmitting the RACH preamble without having performed time synchronization after exiting a sleep mode.

Aspect 25: The method of any of Aspects 1-24, wherein transmitting the RACH preamble further comprises transmitting the RACH preamble without having performed time synchronization or frequency synchronization after exiting a sleep mode.

Aspect 26: A method of wireless communication performed by a network entity, comprising: outputting a physical random access channel (PRACH) configuration indicating a set of resources for a random access channel (RACH) preamble; and receiving the RACH preamble on the set of resources at a starting frequency and in accordance with a frequency hopping pattern, wherein the transmission comprises a backscatter modulation of an input RF signal.

Aspect 27: The method of Aspect 26, wherein the set of resources comprises a set of frequency resources for the RACH preamble.

Aspect 28: The method of any of Aspects 26-27, wherein the set of resources comprises a set of time-frequency resources for the RACH preamble.

Aspect 29: The method of Aspect 28, wherein the PRACH configuration indicates a time gap between reception of a synchronization signal and the set of time-frequency resources.

Aspect 30: The method of any of Aspects 26-29, wherein the set of resources comprises a predefined resource.

Aspect 31: The method of any of Aspects 26-30, further comprising outputting a wakeup signal prior to receiving the RACH preamble, wherein receiving the RACH preamble comprises receiving the RACH preamble based at least in part on the wakeup signal.

Aspect 32: The method of Aspect 31, wherein the PRACH configuration indicates one or more parameters for the wakeup signal.

Aspect 33: The method of Aspect 32, wherein the one or more parameters include at least one of: a periodicity of the wakeup signal, a frequency location of the wakeup signal, or a duration of a time window for transmission of the RACH preamble.

Aspect 34: The method of Aspect 31, wherein receiving the RACH preamble based at least in part on the wakeup signal further comprises receiving the RACH preamble in a time window related to the wakeup signal.

Aspect 35: The method of any of Aspects 26-34, further comprising: outputting a go-to-sleep signal.

Aspect 36: The method of Aspect 35, wherein the PRACH configuration indicates one or more parameters for the go-to-sleep signal.

Aspect 37: The method of Aspect 36, wherein the one or more parameters include at least one of: a periodicity of the go-to-sleep signal, a frequency location of the go-to-sleep signal, or a duration of a time window for transmission of the RACH preamble.

Aspect 38: The method of any of Aspects 26-37, wherein the starting frequency is based at least in part on a random function or a hash.

Aspect 39: The method of any of Aspects 26-38, wherein the starting frequency is based at least in part on a user equipment (UE) sensing a plurality of frequencies.

Aspect 40: The method of any of Aspects 26-39, wherein the starting frequency is based at least in part on an interference threshold.

Aspect 41: The method of any of Aspects 26-40, wherein the starting frequency is based at least in part on the starting frequency having a lowest interference value of interference values of a plurality of frequencies.

Aspect 42: The method of any of Aspects 26-41, wherein the starting frequency is based at least in part on an interference threshold and an interference value of the starting frequency.

Aspect 43: The method of any of Aspects 26-42, wherein the starting frequency is based at least in part on a group indicated by the PRACH configuration.

Aspect 44: The method of any of Aspects 26-43, wherein the set of resources includes a first time resource and a second time resource contiguous with the first time resource.

Aspect 45: The method of any of Aspects 26-44, wherein the set of resources includes a first time resource and a second time resource that is separated from the first time resource in time.

Aspect 46: The method of any of Aspects 26-45, wherein the PRACH configuration indicates a length of the frequency hopping pattern.

Aspect 47: The method of Aspect 46, wherein the length of the frequency hopping pattern is associated with a group indicated by the PRACH configuration.

Aspect 48: The method of any of Aspects 26-47, wherein receiving the RACH preamble further comprises receiving the RACH preamble without having performed time synchronization with a user equipment (UE) after a sleep mode of the UE.

Aspect 49: The method of any of Aspects 26-48, wherein receiving the RACH preamble further comprises receiving the RACH preamble without having performed time synchronization or frequency synchronization with a user equipment (UE) after a sleep mode of the UE.

Aspect 50: An apparatus for wireless communication at a device, comprising a processor; memory coupled with the processor; and instructions stored in the memory and executable by the processor to cause the apparatus to perform the method of one or more of Aspects 1-49.

Aspect 51: A device for wireless communication, comprising a memory and one or more processors coupled to the memory, the one or more processors configured to perform the method of one or more of Aspects 1-49.

Aspect 52: An apparatus for wireless communication, comprising at least one means for performing the method of one or more of Aspects 1-49.

Aspect 53: A non-transitory computer-readable medium storing code for wireless communication, the code comprising instructions executable by a processor to perform the method of one or more of Aspects 1-49.

Aspect 54: A non-transitory computer-readable medium storing a set of instructions for wireless communication, the set of instructions comprising one or more instructions that, when executed by one or more processors of a device, cause the device to perform the method of one or more of Aspects 1-49.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of wireless communication performed by a user equipment (UE), comprising:
receiving a physical random access channel (PRACH) configuration indicating a set of resources for a random access channel (RACH) preamble;
receiving an input radio frequency (RF) signal;
selecting a starting frequency for a frequency hopping pattern for the RACH preamble; and
transmitting the RACH preamble in the set of resources at the starting frequency and in accordance with the frequency hopping pattern, wherein transmitting the RACH preamble comprises a backscatter modulation of the input RF signal.

2. The method of claim 1, wherein the set of resources comprises a set of frequency resources for the RACH preamble.

3. The method of claim 1, wherein the set of resources comprises a set of time-frequency resources for the RACH preamble.

4. The method of claim 3, wherein the PRACH configuration indicates a time gap between reception of a synchronization signal and the set of time-frequency resources.

5. The method of claim 1, wherein the set of resources comprises a predefined resource.

6. The method of claim 1, further comprising receiving a wakeup signal prior to transmitting the RACH preamble, wherein transmitting the RACH preamble comprises transmitting the RACH preamble based at least in part on the wakeup signal.

7. The method of claim 6, wherein the PRACH configuration indicates one or more parameters for the wakeup signal.

8. The method of claim 7, wherein the one or more parameters include at least one of:
a periodicity of the wakeup signal,
a frequency location of the wakeup signal, or
a duration of a time window for transmission of the RACH preamble.

9. The method of claim 6, wherein transmitting the RACH preamble based at least in part on the wakeup signal further comprises transmitting the RACH preamble in a time window related to the wakeup signal.

10. The method of claim 1, further comprising:
receiving a go-to-sleep signal; and
refraining from transmitting the RACH preamble during a time period related to the go-to-sleep signal.

11. The method of claim 10, wherein the PRACH configuration indicates one or more parameters for the go-to-sleep signal, and wherein the one or more parameters include at least one of:
a periodicity of the go-to-sleep signal,
a frequency location of the go-to-sleep signal, or
a duration of a time window for transmission of the RACH preamble.

12. (canceled)

13. The method of claim 1, wherein receiving the PRACH configuration further comprises receiving the PRACH configuration prior to entering a sleep mode, and wherein transmitting the RACH preamble further comprises transmitting the RACH preamble after exiting the sleep mode.

14. The method of claim 1, wherein selecting the starting frequency comprises selecting the starting frequency based at least in part on a random function or a hash.

15. The method of claim 1, further comprising performing sensing of a plurality of frequencies, wherein selecting the starting frequency further comprises selecting the starting frequency based at least in part on the sensing.

16. The method of claim 15, wherein selecting the starting frequency based at least in part on the sensing further comprises:
selecting the starting frequency in accordance with an interference threshold; or
selecting the starting frequency based at least in part on the starting frequency having a lowest interference value of interference values of the plurality of frequencies; or
selecting the starting frequency based at least in part on an interference value of the starting frequency.

17-18. (canceled)

19. The method of claim 1, wherein selecting the starting frequency comprises selecting the starting frequency based at least in part on a group indicated by the PRACH configuration.

20. The method of claim 1, wherein the set of resources includes a first time resource and a second time resource that is separated from the first time resource in time or that is contiguous with the first time resource.

21. (canceled)

22. The method of claim 1, wherein the PRACH configuration indicates a length of the frequency hopping pattern.

23-28. (canceled)

29. A user equipment (UE) for wireless communication, comprising:
a memory; and
one or more processors, coupled to the memory, configured to:
receive a physical random access channel (PRACH) configuration indicating a set of resources for a random access channel (RACH) preamble;
receive an input radio frequency (RF) signal;
select a starting frequency for a frequency hopping pattern for the RACH preamble; and
transmit the RACH preamble in the set of resources at the starting frequency and in accordance with the frequency hopping pattern, wherein transmitting the RACH preamble comprises a backscatter modulation of the input RF signal.

30. A network entity for wireless communication, comprising:
a memory; and
one or more processors, coupled to the memory, configured to:
output a physical random access channel (PRACH) configuration indicating a set of resources for a random access channel (RACH) preamble; and
receive the RACH preamble on the set of resources at a starting frequency and in accordance with a frequency hopping pattern, wherein the transmission comprises a backscatter modulation of an input radio frequency (RF) signal.
